(19) United States
(12) Patent Application Publication
(10) Pub. No.: US 2011/0004456 A1
(43) Pub. Date: Jan. 6, 2011

(54) VIRTUAL NETWORK EMBEDDING METHOD IN WIRELESS TEST-BED NETWORK

(75) Inventors: Keun Mo PARK, Anyang-si (KR); Chong Kwon Kim, Seoul (KR)

Correspondence Address: AMPACC Law Group, PLLC, 6100 219th Street SW, Suite 580, Mountlake Terrace, WA, 98043, US

(73) Assignee: SNU R&DB FOUNDATION, Seoul (KR)

(21) Appl. No.: 12/817,057

(22) Filed: Jun. 16, 2010

(30) Foreign Application Priority Data
Jul. 3, 2009 (KR) 10-2009-0060722

(51) Int. Cl. G06G 7/62

(52) U.S. Cl. 703/19

(57) ABSTRACT

Provided is a technology for providing an efficient embedding method in virtualizing a wireless test-bed network. In a virtual network embedding method in a wireless test-bed network, at least one packing point is generated in a two-dimensional strip comprised of time and frequency bandwidth, and the best virtual network slice according to the packing point is disposed. To dispose the virtual network slice, a set of packing points on the strip is collected, the suitability of the network slice according to each packing point is determined, and the network slice is disposed such that a left bottom point of the network slice is disposed at a suitable packing point. Accordingly, the length of a TDM super frame in the virtual test-bed network can be minimized.

### CROSS-REFERENCE TO RELATED APPLICATIONS

This application claims priority under 35 U.S.C. §119 to Korean Patent Application No. 10-2009-0060722, filed on Jul. 3, 2009, the disclosure of which is incorporated herein by reference in its entirety.

### TECHNICAL FIELD

The present disclosure relates to a method for embedding a virtual network, and in particular, to a technology for providing an efficient method for embedding virtual network into physical network in wireless network.

### BACKGROUND

A test-bed is a platform for a performance test of a large-scale development project, which enables an accurate, explicit and iterative test of scientific theories, computational tools and new technologies.

Recently, researches for test-bed networks have been performed, and virtual test-bed equipments such as PlanetLab and extended VINI of PlanetLab have been constructed.

However, efficient network embedding methods for virtualization of test-bed networks are not yet achieved.

Wireless test-bed networks may be virtualized by the integration of a time division scheme and a frequency division scheme, and may arrange network slices formed of parameters of frequency and time in a strip formed of a two-dimensional space of available frequency and time.

FIGS. 1 to 3 are diagrams illustrating basic strip packing algorithms in virtual network embedding methods according to the related arts 1 to 3.

As illustrated in FIG. 1, the related art 1 sequentially arranges network slices and sequentially arranges the time-slot regions of the arranged network slices in other regions if the frequency band is unsuitable.

That is, if the frequency region of a third slice 30 is unsuitable after arrangement of a first slice 10 and a second slice 20 on a strip 100, the related art 1 arranges the third slice 30 and a fourth slice 40 by moving a time-slot region and also arranges a fifth slice 50 and a sixth slice 60 by moving a time-slot region.

As illustrated in FIG. 2, the related art 2 sequentially arranges network slices and arranges time-slot regions selectively according to frequency regions.

That is, if the frequency region of a third slice is unsuitable after arrangement of a first slice 10 and a second slice 20 on a strip 100, the related art 2 arranges the third slice by moving a time-slot region and arranges a fourth slice 40 and a sixth slice 60 of a small frequency region in the previous time slot.

As illustrated in FIG. 3, the related art 3 selects time slots according to frequency regions and improves the spatial arrangement of the frequency regions for the respective time slots.

However, the related arts 1 to 3 causes a large waste of strip space due to a time-slot difference of each network slice because they arrange network slices by a reference time slot.

FIG. 4 is a diagram illustrating a method for arranging network slices on a strip 100 between a bottom reference 101 and a top reference 102 of a time slot according to the related art 4, which reduces a waste of strip space in the related arts 1 to 3.

However, the related art 4 causes and wastes the empty strip space between slices 10, 20, 30 40 and 70 arranged at the bottom reference 101 and slices 50, 60 and 80 arranged at the top reference 102, thus failing to provide an efficient virtual network embedding method.

Also, the related art is unsuitable for use as a wireless virtual network embedding technology because it does not consider Maximum Slicing Constraints (MSC).

### SUMMARY

Accordingly, an object of the present disclosure is to provide a virtual network embedding method in a wireless test-bed network, which can minimize the super frame length of Time Division Multiplexing (TDM) by efficiently arranging slices on a two-dimensional strip comprised of time and frequency bandwidth.

Another object of the present disclosure is to provide an algorithm for disposing the best network slice according to a packing point generated on a strip.

According to an aspect of the present invention, packing points including coordinate points of available points and a set of minimum coordinate points of the available points are generated and the best packing point among the packing points is used as a connection point of a slice to be subsequently disposed.

According to another aspect of the present invention, a left top coordinate point and a right bottom coordinate point of a rectangular network slice are provided as available points and one of the available points is used as a packing point.

According to yet another aspect of the present invention, a starting point (0, 0) of a strip as a packing point of an initial slice to reduce a spatial waste on the strip.

It is determined whether the network interface restraints and the spatial restraints of a strip are satisfied for determining the suitability of arrangement of network slices.

In one general aspect, a virtual network embedding method in a wireless test-bed network includes: generating at least one packing point in a two-dimensional strip comprised of time and frequency bandwidth; and disposing the best virtual network slice according to the packing point.

In another general aspect, the disposing of the virtual network slice includes: collecting a packing point on the strip; determining the suitability of the network slice according to each packing point; and disposing the network slice such that a left bottom point of the network slice is disposed at a suitable packing point.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIGS. 1 to 4 are diagrams illustrating strip structures for virtual network embedding methods according to the related art.

FIG. 5 is a diagram illustrating a strip structure for a virtual network embedding method in a wireless test-bed network according to an exemplary embodiment of the present invention.

FIG. 6 is a flow chart illustrating a virtual network embedding method in a wireless test-bed network according to an exemplary embodiment.

FIG. 7 is a diagram illustrating an algorithm for a virtual network embedding method in a wireless test-bed network according to an exemplary embodiment.

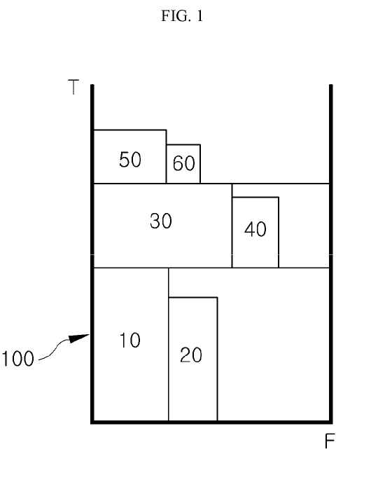

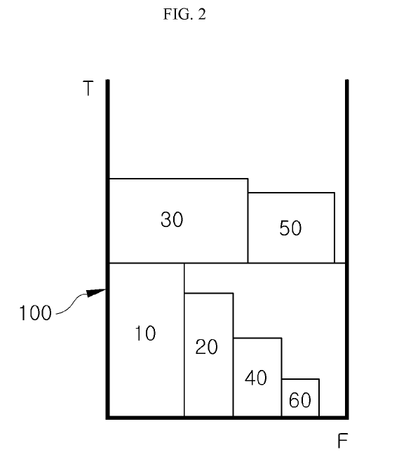

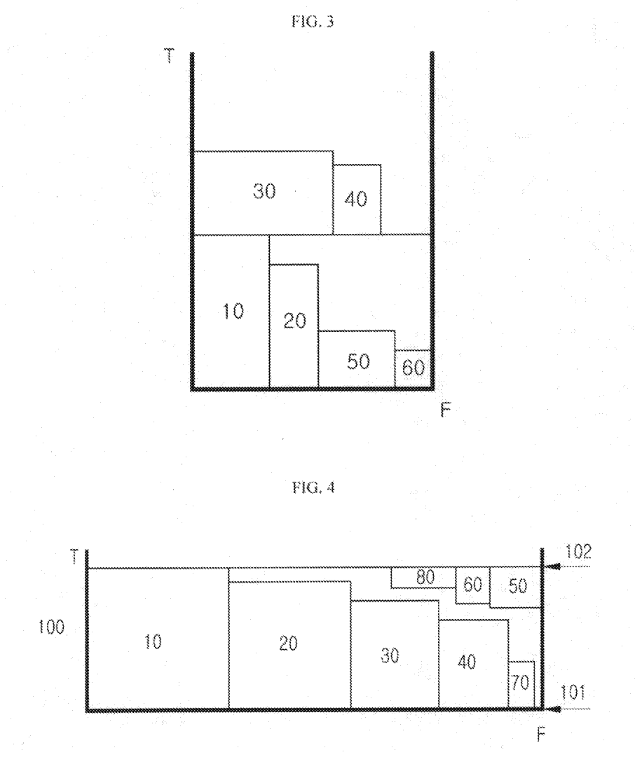

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, a virtual network embedding method in a wireless test-bed network according to an exemplary embodiment will be described in detail with reference to the accompanying drawings.

A virtual network embedding method in a wireless test-bed network according to an exemplary embodiment generates a packing point in a two-dimensional strip comprised of time and frequency bandwidth and disposes the best virtual network slice with reference to the packing point.

In an exemplary embodiment, the two-dimensional strip is formed of a two-dimensional space of frequency bands F and time slots T, wherein the horizontal axis is comprised of frequency bands F and the vertical axis is comprised of time slots T.

The frequency bands F are limited and the time T is variable.

That is, when virtual rectangular network slices formed of the parameters of time and frequency are efficiently arranged in a strip of a virtual rectangular set comprised of a frequency band F (i.e., a fixed bottom side) and a time T (a variable height), the length of a TDM super frame can be reduced.

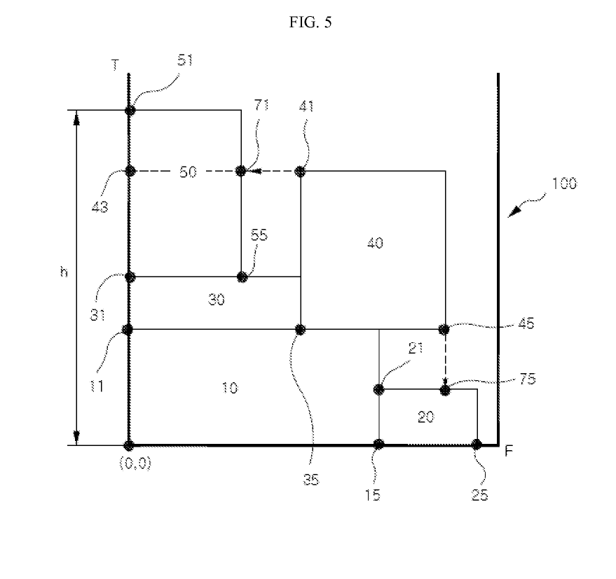

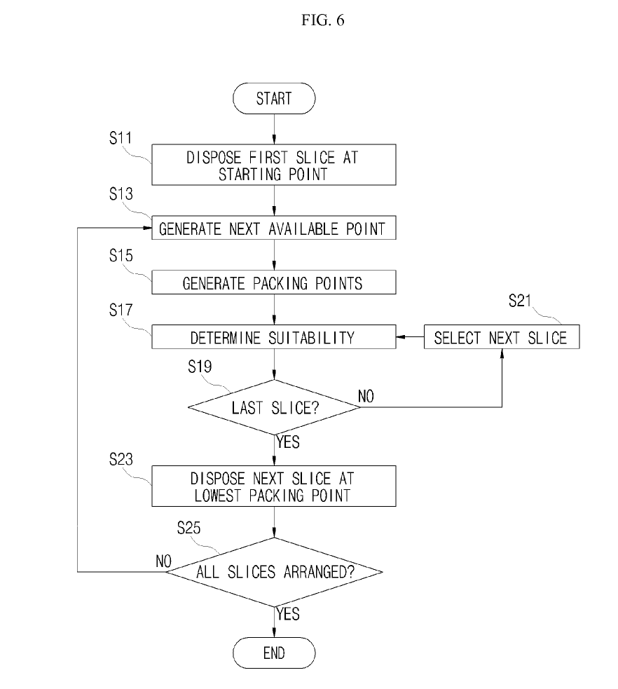

FIG. 5 is a diagram illustrating the arrangement of network slices in a strip 100 according to an exemplary embodiment. FIG. 6 is a flow chart illustrating a method for disposing the optimal virtual network slices in the strip 100 according to an exemplary embodiment.

Referring to FIGS. 5 and 6, in operation S11, a first slice 10 (i.e., an initial slice) is disposed at the starting point (0, 0) of a strip.

According to the slice disposing method of an exemplary embodiment, a the left bottom coordinate point of the first slice is disposed at a packing point, wherein the starting point (0, 0) of the strip is the first available point of the first slice and becomes the packing point.

If two or more network slices are arranged in the strip 100, the slice with the largest frequency band f (i.e., slice width) becomes the first slice.

In operation S13, available points of the next slice are generated.

The available points include a first available point (i.e., a left top coordinate point of the first network slice) and a second available point (i.e., a right bottom coordinate point of the first network slice).

Thus, in an exemplary embodiment, the available points of the next slice include a first available point 11 and a second available point 15.

In operation S15, packing points are generated.

The candidates of packing points are determined according to the following terms.

First, minimum distance points of a horizontal direction from the left top available point of the packed slice, i.e., a point meeting the time domain wall of the strip and a point meeting the previously packed slice wall are selected.

Second, minimum distance points of a vertical direction in the right bottom available point of the packed slice, i.e., a point meeting the frequency band bottom of the strip and a point meeting the previously packed slice wall are also selected.

Third, the right bottom available point of the packed slice is selected, too.

As described above, the packing points are re-generated by the available points of the slice disposed in the strip 100.

In order to choose an optimal packing point among a plurality of the above candidate packing points, the priority is given to the packing point having the lowest value in time dimension.

It gives the efficient arrangement of the network slices in the strip 100 comprised of the fixed frequency F and the variable time T, thereby reducing the length of the TDM super frame.

Thus, the second available point 15 of the first slice 10 may be chosen as the lowest packing point.

Then, the suitability of non-arranged network slices according to the packing point is determined in operation S17.

The suitability of the network slice is determined on the basis of whether it overlaps with a slice previously disposed in the strip and whether the maximum slice restraints according to the network interface are satisfied.

That is, it should be determined if the second slice overlaps with the first slice 10 previously disposed in the strip 100, when the second slice is disposed at the packing point 15.

If the second slice does not overlap with the first slice 10, it is determined that the arrangement of the second slice is suitable.

Also, when the second slice 20 is disposed at the packing point 15, the Maximum Slicing Constraints (MSC) according to the network interface must be satisfied.

The reason for this is that, for the number of slices of the frequency dimension F of the strip 100, the number of slices arrangeable in a single time T must be equal to or smaller than the number of network interfaces.

If the Maximum Slicing Constraints (MSC) according to the network interface is satisfied, the second slice can be disposed.

The determination of the suitability of the network slice is performed on all of the non-arranged network slices. Thus, it is determined if it is the last slice in operation S19.

If there is a network slice that does not undergo the determination of the suitability of slice arrangement, the next slice is selected in operation S21.

If there are two suitable slices, the slice with larger frequency bandwidth becomes preferential.

Since it has been determined that the arrangement of the second slice 20 at the packing point 15 is suitable through operations 17 to 21, the left bottom coordinate point of the second slice 20 is disposed at the lowest packing point 15 in operation S23.

In operation S25, it is determined whether all the slices have been arranged in the strip.

If all the slices have been arranged in the strip (in operation S25), the method is ended; and if not, the method returns to operation S13.

That is, the exemplary embodiment is based on a greedy scheme that selects a packing point iteratively until all the slices are disposed at suitable positions.

The greedy scheme means a scheme that reaches the final solution by selecting the best answer whenever a determination must be made to obtain the best solution.

In an exemplary embodiment, first to fifth slices are disposed according to the above method. When a sixth slice is to be disposed, a set of available points becomes {21, 25, 41, 45, 51, 55} and a set of packing points becomes {21, 25, 45, 51, 55, 71, 75}.

The packing points 71 and 75 correspond to the conversion to the first available point 41 and the second available point 45 of the fourth slice 40.

That is, a coordinate point corresponding to the minimum frequency F of the same time t of the first available point 41 of the fourth slice 40 becomes the packing point 71, and a coordinate point corresponding to the minimum time T of the same frequency F of the second available point 45 of the fourth slice 40 becomes the packing point 75.

Also, the packing point 45 is included as the right bottom point of the fourth slice 40 in the packing point.

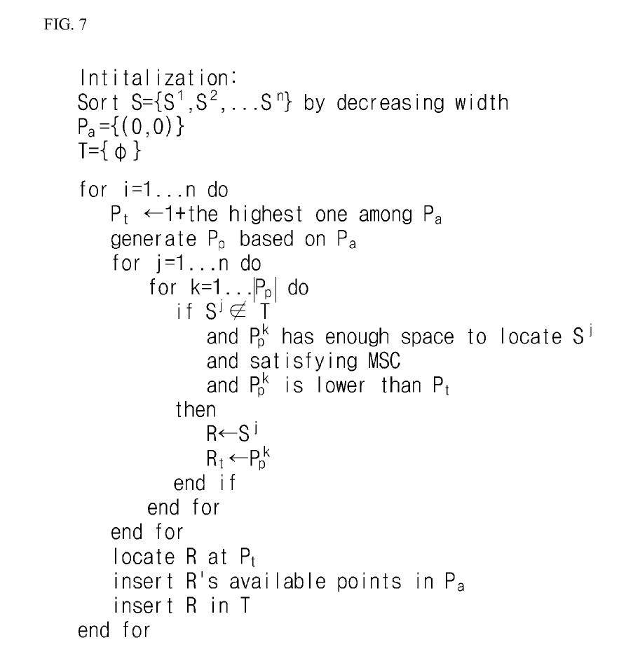

FIG. 7 is a diagram illustrating an algorithm for disposing virtual network slices in the strip 100 according to an exemplary embodiment.

In the algorithm of FIG. 7, S denotes a slice, N denotes the number of slices, and T denotes a set of slices disposed in the strip.

Also, PP denotes a packing point, Pa denotes an available point, and R and Pt denotes temporary parameters for memorizing the slice and the corresponding packing point in selecting the best slice and the lowest packing point among the packing points.

The algorithm for disposing the virtual network slices in the strip 100 according to the exemplary embodiment corresponds to a heuristic algorithm that can derive the practically satisfactory results within a limited time.

The virtual network embedding method in the wireless test-bed network according to the exemplary embodiments can reduce the height h of the strip by the efficient arrangement of the slices in the strip, thereby making it possible to reduce the length of the TDM super frame in the wireless test-bed network.

Although the exemplary embodiments have been described above, the scope of the inventive concept is not limited to the exemplary embodiments. The inventive concept may be implemented in virtual network embedding methods on various wireless test-bed networks without departing from the sprit and scope thereof.

As described above, a virtual network embedding method in a wireless test-bed network according to the exemplary embodiments can minimize the super frame length of Time Division Multiplexing (TDM) by efficiently arranging slices on a two-dimensional strip comprised of time and frequency bandwidth.

Also, the virtual network embedding method can provide an algorithm for disposing the best network slice according to a packing point generated on a strip.

Also, the virtual network embedding method can generate packing points including coordinate points of available points and a set of minimum coordinate points of the available points and use the best packing point among the packing points as a connection point of a slice to be subsequently disposed.

Also, the virtual network embedding method can provide a left top coordinate point and a right bottom coordinate point of a rectangular network slice as an available point and use the available point as a packing point.

Also, the virtual network embedding method can use a starting point (0, 0) of a strip as a packing point of an initial slice to reduce a spatial waste on the strip.

Also, the virtual network embedding method can determine the suitability of arrangement of network slices according to whether the network interface restraints and the spatial restraints of a strip are satisfied.

As the inventive concept may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A virtual network embedding method in a wireless test-bed network, comprising:
generating at least one packing point in a two-dimensional strip comprised of time and frequency bandwidth; and
disposing the best virtual network slice according to the packing point.

2. The virtual network embedding method of claim 1, wherein the disposing of the virtual network slice comprises:
collecting a packing point on the strip;
determining the suitability of the network slice according to each packing point; and
disposing the network slice such that a left bottom point of the network slice is disposed at a suitable packing point.

3. The virtual network embedding method of claim 2, wherein the packing point is a set of available points of the network slice and a minimum distance coordinate point of the available point.

4. The virtual network embedding method of claim 3, wherein the available point includes a first available point that is a left top coordinate point of a rectangular network slice, and a second available point that is a right bottom coordinate point.

5. The virtual network embedding method of claim 2, wherein the network slice initially disposed on the strip is configured to dispose a starting point (0, 0) of the strip as a suitable packing point.

6. The virtual network embedding method of claim 2, wherein the suitability of the network slice according to each packing point is determined according to whether there is an overlap with the previously disposed network slice in the strip and whether the maximum slicing constraints according to the network interface are satisfied.
